(19) United States
(12) Patent Application Publication
(10) Pub. No.: US 2015/0088840 A1
(43) Pub. Date: Mar. 26, 2015

(54) DETERMINING SEGMENT BOUNDARIES FOR DEDUPLICATION

(71) Applicants: Kave Eshghi, Los Altos, CA (US); David M. Falkinder, Bristol Avon (GB); Mark D. Lillibridge, Mountain View, CA (US)

(72) Inventors: Kave Eshghi, Los Altos, CA (US); David M. Falkinder, Bristol Avon (GB); Mark D. Lillibridge, Mountain View, CA (US)

(21) Appl. No.: 14/395,491

(22) PCT Filed: May 1, 2012
(86) PCT No.: PCT/US2012/035917

§ 371 Date: Oct. 19, 2014

(51) Int. Cl. G06F 17/30

(52) U.S. Cl. CPC G06F 17/30159
USPC 707/692

(57) ABSTRACT

A sequence of hashes is received. Each hash corresponds to a data chunk of data to be deduplicated. Locations of previously stored copies of the data chunks are determined, the locations determined based on the hashes. A breakpoint in the sequence of data chunks is determined based on the locations, the breakpoint forming a boundary of a segment of data chunks.

### BACKGROUND

Administrators strive to efficiently manage file servers and file server resources while keeping networks protected from unauthorized users yet accessible to authorized users. The practice of storing files on servers rather than locally on users' computers has led to identical data being stored at multiple locations in the same system and even at multiple locations in the same server.

Deduplication is a technique for eliminating redundant data, improving storage utilization, and reducing network traffic. Storage-based data deduplication inspects large volumes of data and identifies entire files, or sections of files, that are identical, then reduces the number of instances of identical data. For example, an email system may contain 100 instances of the same one-megabyte file attachment. Each time the email system is backed up, each of the 100 instances of the attachment is stored, requiring 100 megabytes of storage space. With data deduplication, only one instance of the attachment is stored, thus saving 99 megabytes of storage space.

### BRIEF DESCRIPTION OF THE DRAWINGS

For a detailed description of exemplary embodiments of the invention, reference will now be made to the accompanying drawings in which:

FIG. 1A illustrates a system for determining segment boundaries;

FIG. 1B illustrates a system for determining segment boundaries;

FIG. 2 illustrates a method for determining segment boundaries;

FIG. 3 illustrates a storage device for determining segment boundaries;

FIGS. 4A and 4B show a diagram of determining segment boundaries.

### NOTATION AND NOMENCLATURE

As used herein, the term “chunk” refers to a continuous subset of a data stream.

As used herein, the term “segment” refers to a group of continuous chunks. Each segment has two boundaries, one at its beginning and one at its end.

As used herein, the term“hash” refers to an identification of a chunk that is created using a hash function.

As used herein, the term “block” refers to a division of a file or data stream that is interleaved with other files or data streams. For example, interleaved data may comprise 1a, 2a, 3a, 1b, 2b, 1c, 3b, 2c, where 1a is the first block of underlying stream one, 1b is the second block of underlying stream one, 2a is the first block of underlying stream two, etc. In some cases, the blocks may differ in length.

As used herein, the term “deduplicate” refers to the act of logically storing a chunk, segment, or other division of data in a storage system or at a storage node such that there is only one physical copy (or, in some cases, a few copies) of each unique chunk at the system or node. For example, deduplicating ABC, DBC and EBF (where each letter represents a unique chunk) against an initially-empty storage node results in only one physical copy of B but three logical copies. Specifically, if a chunk is deduplicated against a storage location and the chunk is not previously stored at the storage location, then the chunk is physically stored at the storage location. However, if the chunk is deduplicated against the storage location and the chunk is already stored at the storage location, then the chunk is not physically stored at the storage location again. In yet another example, if multiple chunks are deduplicated against the storage location and only some of the chunks are already stored at the storage location, then only the chunks not previously stored at the storage location are stored at the storage location during the deduplication.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

During chunk-based deduplication, unique chunks of data are each physically stored once no matter how many logical copies of them there may be. Subsequent chunks received may be compared to stored chunks, and if the comparison results in a match, the matching chunk is not physically stored again. Instead, the matching chunk may be replaced with a reference that points to the single physical copy of the chunk. Processes accessing the reference may be redirected to the single physical instance of the stored chunk. Using references in this way results in storage savings. Because identical chunks may occur many times throughout a system, the amount of data that must be stored in the system or transferred over the network is reduced. However, interleaved data is difficult to deduplicate efficiently.

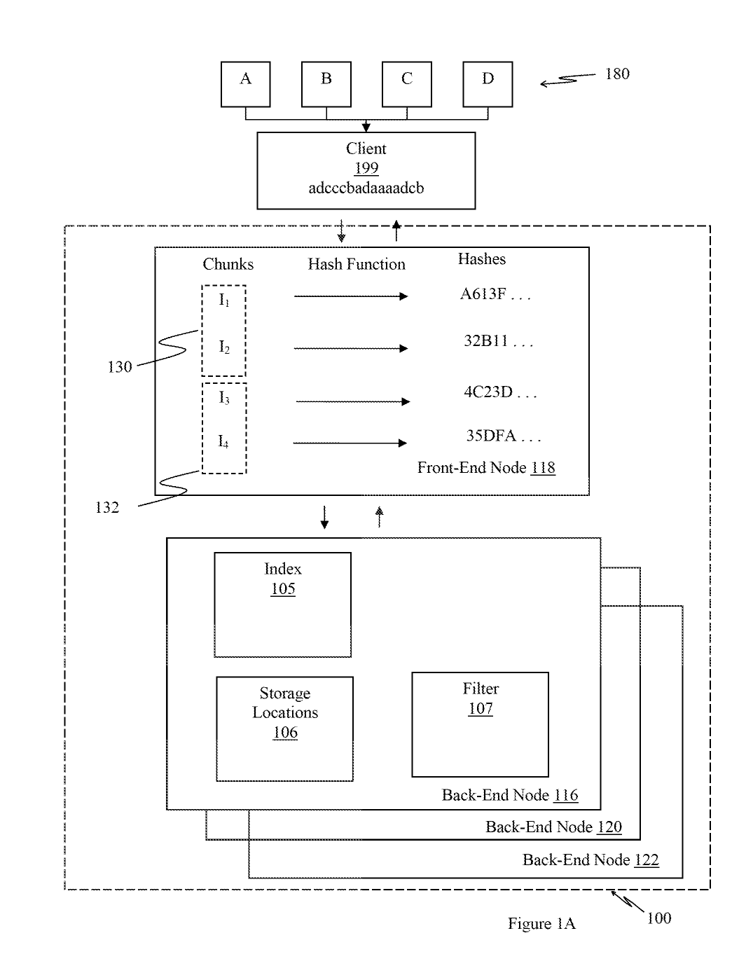

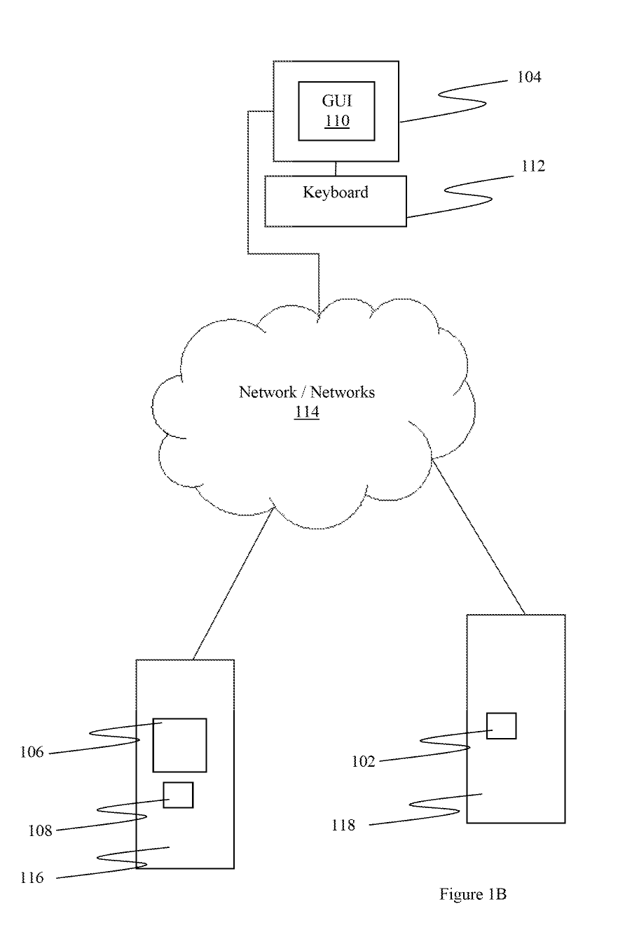

FIG. 1A illustrates a system 100 for smart segmentation. Interleaved data refers to a stream of data produced from different underlying sources by interleaving data from the different underlying sources. For example, four underlying sources of data A, B, C, and D 180 may be interleaved to produce a stream adcccbadaaaadcb, where a represents a block of data from source A, b represents a block of data from source B, c represents a block of data from source C, and d represents a block of data from source D.

Recovering the underlying source streams is difficult without understanding the format used to interleave the streams. Because different backup agents are made by different companies that interleave data in different ways, and because methods of interleaving change over time, it may not be cost-effective to produce a system that can un-interleave all interleaved data. It may therefore be useful for a system to be able to directly handle interleaved data.

During deduplication, hashes of the chunks may be created in real time on a front end, which communicates with one or more deduplication back ends, or on a client 199. For example, the front end 118, which communicates with one or more back ends, which may be deduplication backend nodes 116, 120, 122. In various embodiments, front ends and back ends also include other computing devices or systems. A chunk of data is a continuous subset of a data stream that is produced using a chunking algorithm that may be based on size or logical file boundaries. Each chunk of data may be input to a hash function that may be cryptographic; e.g., MD5 or SHA1. In the example of FIG. 1A, chunks I₁, I₂, I₃, and I₄ result in hashes A613F . . . , 32B11 . . . , 4C23D . . . , and 35DFA . . . respectively. In at least some embodiments, each chunk may be approximately around 4 kilobytes, and each hash may be approximately 16 to 20 bytes.

Instead of chunks being compared for deduplication purposes, hashes of the chunks may be compared. Specifically, identical chunks will produce the same hash if the same hashing algorithm is used. Thus, if the hashes of two chunks are equal, and one chunk is already stored, the other chunk need not be physically stored again; this conserves storage space. Also, if the hashes are equal, underlying chunks themselves may be compared to verify duplication, or duplication may be assumed. Additionally, the system 100 may comprise one or more backend nodes 116, 120, 122. In at least one implementation, the different backend nodes 116, 120, 122 do not usually store the same chunks. As such, storage space is conserved because identical chunks are not stored between backend nodes 116, 120, 122, but segments (groups of chunks) must be routed to the correct backend node 116, 120, 122 to be effectively deduplicated.

Comparing hashes of chunks can be performed more efficiently than comparing the chunks themselves, especially when indexes and filters are used. To aid in the comparison process, indexes 105 and/or filters 107 may be used to determine which chunks are stored in which storage locations 106 on the backend nodes 116, 120, 122. The indexes 105 and/or filters 107 may reside on the backend nodes 116, 120, 122 in at least one implementation. In other implementations, the indexes 105, and/or filters 107 may be distributed among the front end nodes 118 and/or backend nodes 116, 120, 122 in any combination. Additionally, each backend node 116, 120, 122 may have separate indexes 105 and/or filters 107 because different data is stored on each backend node 116, 120, 122.

In some implementations, an index 105 comprises a data structure that maps hashes of chunks stored on that backend node to (possibly indirectly) the storage locations containing those chunks. This data structure may be a hash table. For a non-sparse index, an entry is created for every stored chunk. For a sparse index, an entry is created for only a limited fraction of the hashes of the chunks stored on that backend node. In at least one embodiment, the sparse index indexes only one out of every 64 chunks on average.

Filter 107 may be present and implemented as a Bloom filter in at least one embodiment. A Bloom filter is a space-efficient data structure for approximate set membership. That is, it represents a set but the represented set may contain elements not explicitly inserted. The filter 107 may represent the set of hashes of the set of chunks stored at that backend node. A backend node in this implementation can thus determine quickly if a given chunk could already be stored at that backend node by determining if its hash is a member of its filter 107.

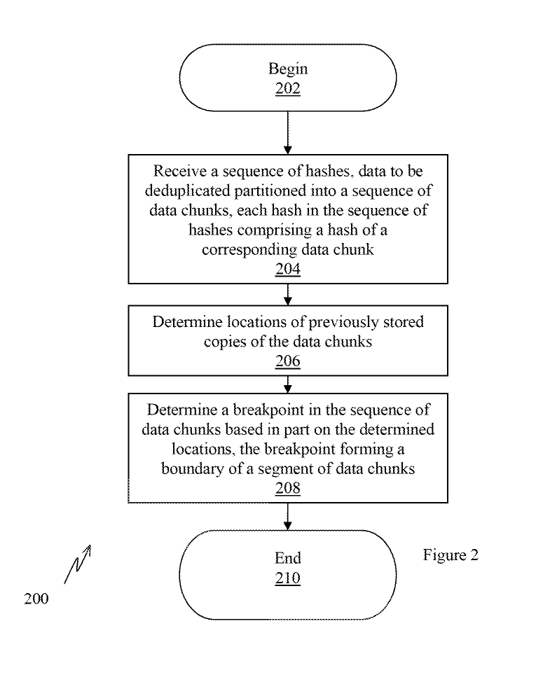

Which backend node to deduplicate a chunk against (i.e., which backend node to route a chunk to) is not determined on a per chunk basis in at least one embodiment. Rather, routing is determined a segment (a continuous group of chunks) at a time. The input stream of data chunks may be partitioned into segments such that each data chunk belongs to exactly one segment, FIG. 1A illustrates that chunks I₁ and I₂ comprise segment 130, and that chunks I₃ and I₄ comprise segment 132. In other examples, segments may contain thousands of chunks. A segment may comprise a group of chunks that are adjacent in the interleaved stream. The boundaries of segments are breakpoints. As illustrated the breakpoint between segment 130 and 132 lies between I₂ and I₃. As detailed in the method of FIG. 2, a suitable breakpoint in the stream may be determined based on locations of previously stored chunks. The breakpoint is determined by the front-end node 118, backend node 116, 120, 122, or both the front-end node 118 and backend node 116, 120, 122 in various embodiments.

Although FIG. 1A shows only one front end 118, systems may contain multiple front ends, each implementing similar functionality. Clients 199, of which only one is shown, may communicate with the same front end 118 for long periods of time. In one implementation, the functionality of front end 118 and the backend nodes 116, 120, 122 are combined in a single node.

FIG. 1B illustrates a hardware view of the system 100. Components of the system 100 may be distributed over a network or networks 114 in at least one embodiment. Specifically, a user may interact with GUI 110 and transmit commands and other information from an administrative console over the network 114 for processing by front-end node 118 and backend node 116. The display 104 may be a computer monitor, and a user may manipulate the GUI via the keyboard 112 and pointing device or computer mouse (not shown). The network 114 may comprise network elements such as switches, and may be the Internet in at least one embodiment. Front-end node 118 comprises a processor 102 that performs the hashing algorithm in at least one embodiment. In another embodiment, the system 100 comprises multiple front-end nodes. Backend node 116 comprises a processor 108 that may access the indexes 105 and/or filters 107, and the processor 108 may be coupled to storage locations 106. Many configurations and combinations of hardware components of the system 100 are possible. In another embodiment, the system 100 comprises multiple back-end nodes.

In at least one embodiment, one or more clients 199 are backed up periodically by scheduled command. The virtual tape library (“VLT”) or network file system (“NFS”) protocols may be used as the protocol to backup a client 199.

FIG. 2 illustrates a method 200 of smart segmentation beginning at 202 and ending at 210. At 204, a sequence of hashes is received. For example, the sequence may be generated by front-end node 118 from sequential chunks of interleaved data scheduled for deduplication. The sequential chunks of interleaved data may have been produced on front-end node 118 by chunking interleaved data received from client 199 for deduplication. The chunking process partitions the interleaved data into a sequence of data chunks. A sequence of hashes may in turn be generated by hashing each data chunk.

Alternatively, the chunking and hashing may be performed by the client 199, and only the hashes may be sent to the front-end node 118. Other variations are possible.

As described above, interleaved data may originate from different sources or streams. For example, different threads may multiplex data into a single file resulting in interleaved data. Each hash corresponds to a chunk. In at least one embodiment, the amount of hashes received corresponds to chunks with lengths totaling three times the length of an average segment. Although the system is discussed using interleaved data as examples, in at least one example non-interleaved data is handled similarly as well.

At 206, locations of previously stored copies of the data chunks are determined. In at least one example, a query to the backends 116, 120, 122 is made for location information and the locations may be received as results of the query. In one implementation, the front-end node 118 may broadcast the sequence of hashes to the backend nodes 116, 120, 122, each of which may then determine which of its locations 106 contain copies of the data chunks corresponding to the sent hashes and send the resulting location information back to front-end node 118. In a one node implementation, the determining may be done directly without any need for communication between nodes.

For each data chunk, it may be determined which locations already contain copies of that data chunk. This determining may make use of heuristics. In some implementations, this determining may only be done for a subset of the data chunks.

The locations may be as general as a group or cluster of backend nodes or a particular backend node, or the locations may be as specific as a chunk container (e.g., a file or disk portion that stores chunks) or other particular location on a specific backend node. Determining locations may comprise searching for one or more of the hashes in an index 105 such as a full chunk index or a sparse index, or a set or filter 107 such as a Bloom filter. The determined locations may be a group of backend nodes 116, 120, 122, a particular backend node 116, 120, 122, chunk containers, stores, or storage nodes. For example, each backend node may return a list of sets of chunk container identification numbers to the front-end node 118, each set pertaining to the corresponding hash/data chunk and the chunk container identification numbers identifying the chunk containers stored at that backend node in which copies of that data chunk are stored. These lists can be combined on the front-end node 118 into a single list that gives for each data chunk, the chunk container ID/backend number pairs identifying chunk containers containing copies of that data chunk.

In another embodiment, the returned information identifies only which data chunks that backend node has copies for. Again, the information can be combined to produce a list giving for each data chunk, the set of backend nodes containing copies of that data chunk.

In yet another embodiment that has only a single node, the determined information may just consist of a list of sets of chunk container IDs because there is no need to distinguish between different backend nodes. As the skilled practitioner is aware, there many different ways location information can be conveyed.

At 208, a breakpoint in the sequence of chunks is determined based at least in part on the determined locations. This breakpoint may be used to form a boundary of a segment of data chunks. For example, if no segments have yet been produced, then the first segment may be generated as the data chunks from the beginning of the sequence to the data chunk just before the determined breakpoint. Alternatively, if some segments have already been generated then the next segment generated may consist of the data chunks between the end of the last segment generated and the newly determined breakpoint.

Each iteration of FIGS. 2 (202 to 210) may determine a new breakpoint and hence determine a new segment. Each additional iteration may reuse some of the work or information of the previous iterations. For example, the hashes of the data chunks not formed into a segment by the previous iteration and their determined locations may be considered again by the next iteration for possible inclusion in the next segment determined. The process of partitioning a sequence of data chunks into segments is called segmentation.

Determining a break point may comprise determining regions in the sequence of data chunks based in part on which data chunks have copies in the same determined locations and then determining the breakpoint in the sequence of data chunks based on the regions. For example, the regions in the sequence of data chunks may be determined such that at least 90% of the data chunks with determined locations of each region have previously stored copies in a single location. That is, for each region there is a location in which at least 90% of the data chunks with determined locations have previously stored copies. Next, a break point in the sequence of data chunks may be determined based on the regions.

Hashes and chunks corresponding to the same or similar locations may be grouped. For example, the front-end node 118 may group hashes and corresponding data chunks corresponding to one location into a segment, and may group adjacent hashes and corresponding data chunks corresponding to a different location into another segment. As such, the breakpoint is determined to lie between the two segments.

The front-end node 118 may deduplicate the newly formed segment against one of the backend nodes as a whole. That is, the segment may be deduplicated only against data contained in one of the backend nodes and not against data contained in the other backend nodes. This is in contrast to, for example, the first half of a segment being deduplicated against one backend node and the second half the segment being deduplicated against another backend node. In at least one embodiment, the data contained in a backend node may be in storage attached to the backend node, under control of the backend node, or the primary responsibility of the backend node rather than physically part of it.

The segment may be deduplicated only against data contained in one of a plurality of nodes. In one embodiment, the chosen backend node 116, 120, or 122 identifies the storage locations 106 against which the segment will be deduplicated.

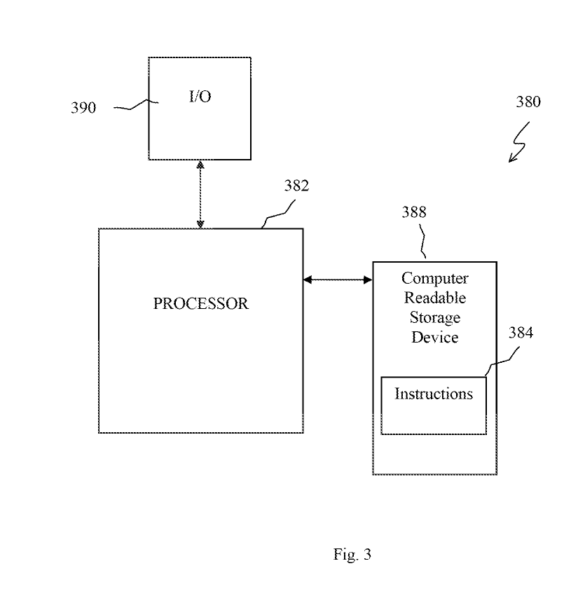

The system described above may be implemented on any particular machine or computer with sufficient processing power, memory resources, and throughput capability to handle the necessary workload placed upon the computer. FIG. 3 illustrates a particular computer system 380 suitable for implementing one or more examples disclosed herein. The computer system 380 includes one or more hardware processors 382 (which may be referred to as central processor units or CPUs) that are in communication with memory devices including computer-readable storage device 388 and input/output (I/O) 390 devices. The one or more processors may be implemented as one or more CPU chips.

In various embodiments, the computer-readable storage device 388 comprises a non-transitory storage device such as volatile memory (e.g., RAM), non-volatile storage (e.g., Flash memory, hard disk drive, CD ROM, etc.), or combinations thereof. The computer-readable storage device 388 may comprise a computer or machine-readable medium storing software or instructions 384 executed by the processor(s) 382. One or more of the actions described herein are performed by the processor(s) 382 during execution of the instructions 384.

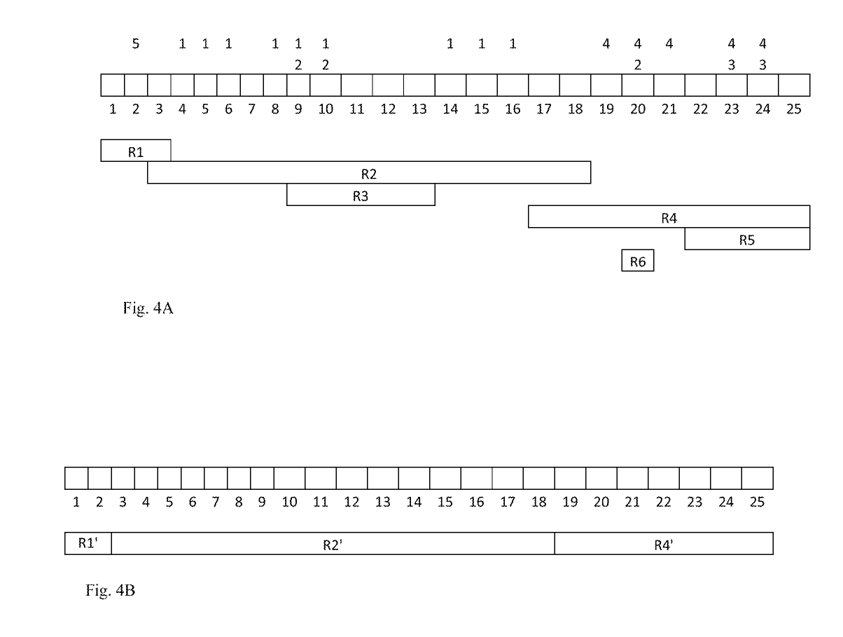

FIG. 4A illustrates an example of one way of determining a set of regions. Here, a sequence of 25 chunks is shown. In various examples, thousands of chunks may be processed at a time. For each chunk, its determined locations are shown above that chunk. For example, chunk number 1 has not been determined to have a copy in any location 106. It may represent new data that has not yet been stored in at least one example. Alternatively, the heuristics used to determine chunk locations may have made an error in this case. Chunk number 2, by contrast, has been determined to be in location 5. Chunk number 3 also has no determined location, but chunk numbers 4 through 6 have been determined to have copies in location 1. Note that some chunks have been determined to be in multiple locations; for example, chunk numbers 9 and 10 have been determined to have copies in both locations 1 and 2.

Shown below the chunks are a number of regions, R1 through R6. For example, region R1 comprises chunks 1 through 3 and region R2 comprises chunks 3 through 18. These regions (R1-R6) have been determined by finding the maximal continuous subsequences such that each subsequence has an associated location and every data chunk in that subsequence either has that location as one of its determined locations or has no determined location. For example region R1's associated location is 5; one of its chunks (# 2) has 5 as one of its determined locations and the other two chunks (#s 1 and 3) have no determined location. Similarly, R2's associated location is 1, R3 and R6's associated location is 2, R4's associated location is 4, and R5's associated location is 3.

Each of these regions is maximal because it cannot be extended in either direction by even one chunk without violating the example region generation rule. For example, chunk 4 cannot be added to region R1 because it has a determined location and none of its determined locations is 5. Each region represents a swath of data that resides in one location; thus a breakpoint in the middle of a region will likely cause loss of deduplication. Because new data (e.g., data chunks without locations) can be stored anywhere without risk of creating intermediate duplication, the new data effectively acts like a wildcard, allowing it to be part of any region, thus extending the region.

There are many ways of determining regions. For example, regions need not be maximal but may be required to end with data chunks having determined locations. In another example, in order to deal with noise, regions may be allowed to incorporate a small amount of data chunks with determined locations that do not include the region's primary location. For example, in FIG. 4A, region R2 might be allowed to exist as shown even if chunk 13 was determined to be located in location 5. In another example, there may be a limit to how many such chunks a region may incorporate; the limit may be absolute (e.g., no more than five chunks) or relative (e.g., no more than 10% of the data chunks with determined locations may be have determined locations other than the associated location).

In another example, new data chunks may be handled differently. Instead of treating their locations as wildcards, able to belong to any region, they may be regarded as being located in both the determined location of the nearest chunk to the left with a determined location and the determined location of the nearest chunk to the right with a determined location. If the nearest chunk with a determined location is too far away (e.g., exceeds a threshold of distance away), then its determined locations may be ignored. Thus new data chunks too far away from old chunks may be regarded as having no location, and thus either incorporable in no region, or only in incorporable in special regions. Such a special reason may be one that contains only similar new data chunks far away from old data chunks in at least one example. In another example, new data chunks may be regarded as being in the determined locations of the nearest data chunk with a determined location. In the case of FIG. 4A, chunk 11 may treated as if it was in locations 1 & 2, chunk 13 may be treated as if it was in location 1, and chunk 12 may be treated as being in either locations 1&2, 1, or both depending on tiebreaking rules.

Because “breaking” (i.e., determining boundaries) the middle of a region is likely to cause duplication, it should be avoided if possible. Moreover, breaking in the middle of a larger region rather than a smaller region and breaking closer to the middle of a region will likely cause more duplication. As such, these scenarios should be minimized as well. By taking the regions into account, an efficient breakpoint may be determined based on the regions. Efficient breakpoints cause less duplication of stored data.

There are many ways of determining boundaries. One example involves focusing on preserving the largest regions, e.g., selecting the largest regions and shortening the parts of the other regions that overlap it. Shorten here means make the smaller region just small enough so that it does not overlap the largest region; this may require removing the smaller region entirely if is completely contained in the largest region. In the case of FIG. 4A, the largest region is R2. R1 may be shortened to chunks 1-2, and R3 may be discarded as it entirely overlaps R2. R4 may be shortened to chunks 19-25. The next largest region remaining may be selected and the process repeated until none of the remaining regions overlap. The result of this process for FIG. 4A is shown in FIG. 4B.

Potential breakpoints may lie just before the first chunk and after the last chunk of each of the three resulting regions in FIG. 4B (R1′, R2′, and R4′). In one example, the earliest such a breakpoint between a required minimum segment size and a required maximum segment size is chosen. If no such breakpoint exists, either the maximum segment size may be chosen or a backup segmentation scheme that does not take determined chunk locations into account may be applied. If, for the purposes of the example of FIG. 4A, it is assumed a minimum segment size of 8 and a maximum segment size of 23, then a breakpoint between chunk 18 and 19 will be chosen. The first generated segment may then consist of chunks 1 through 18. Chunk 19 may form the beginning of the second segment. Note that this puts the data in location 1 together in a single segment as well as the data in location 4 in a different single segment.

Many variations of this implementation are possible. For example, instead of shortening regions, rules may comprise discarding maximal regions below a threshold size and prioritizing the resulting potential breakpoints by how large their associated regions are. Lower priority breakpoints might be used only if higher priority breakpoints fall outside the minimum and maximum segment size requirements.

In at least one example, two potential breakpoints are separated by new data not belonging to any region. In such a case, the breakpoint could be determined to be anywhere between the two potential breakpoints without affecting which regions get broken. In various examples, different rules would allow for selection of breakpoints in the middle between the regions or at one of the region ends.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A non-transitory computer-readable storage device comprising executable instructions that, when executed, cause one or more processors to:
receive a sequence of hashes, data to be deduplicated partitioned into a sequence of data chunks, each hash in the sequence of hashes comprising a hash of a corresponding data chunk;
determine locations of previously stored copies of the data chunks, the locations determined based on the hashes; and
determine a breakpoint in the sequence of data chunks based in part on the determined locations, the breakpoint forming a boundary of a segment of data chunks.

2. The device of claim 1, wherein the instructions further cause the one or more processors to deduplicate the segment as a whole.

3. The device of claim 1, wherein the instructions further cause the one or more processors to deduplicate the segment only against data contained in one of a plurality of nodes.

4. The device of claim 1, wherein the locations are determined by searching for one or more of the hashes in an index, a sparse index, a set, or a Bloom filter.

5. The device of claim 1, wherein determining a break point causes the one or more processors to:
determine regions in the sequence of data chunks based in part on which data chunks have copies in the same locations;
determine a break point in the sequence of data chunks based on the regions.

6. The device of claim 5, wherein for each region there is a location in which at least 90% of the data chunks with determined locations have previously stored copies.

7. A method, comprising:
receiving, by a processor, a sequence of hashes, data to be deduplicated partitioned into a sequence of data chunks, each hash in the sequence of hashes comprising a hash of a corresponding data chunk;
determining locations of previously stored copies of the data chunks; and
determining a breakpoint in the sequence of data chunks based in part on the determined locations, the breakpoint forming a boundary of a segment of data chunks.

8. The method of claim 7, further comprising deduplicating the segment as a whole.

9. The method of claim 7, wherein the determined locations are chunk containers, stores, or storage nodes.

10. The method of claim 7, wherein the locations are determined by looking up one or more of the hashes in an index, a sparse index, a set, or a Bloom filter.

11. The method of claim 7, wherein determining a break point comprises:
determining regions in the sequence of data chunks based in part on which data chunks have copies in the same determined locations;
determining a break point in the sequence of data chunks based on the regions.

12. The method of claim 11, wherein for each region there is a location in which at least 90% of the data chunks with determined locations have previously stored copies.

13. The method of claim 11, wherein determining the locations comprises querying for location information.

14. A device comprising:
one or more processors;
a memory coupled to the processors;
the one or more processors to
receive a sequence of hashes, data to be deduplicated partitioned into a sequence of data chunks, each hash in the sequence of hashes comprising a hash of a corresponding data chunk;
determine locations of previously stored copies of the data chunks, the locations determined based on the hashes; and
determine a breakpoint in the sequence of data chunks based on the locations, the breakpoint forming a boundary of a segment of data chunks.

15. The device of claim 14, wherein determining the breakpoint comprises:
determine regions in the sequence of data chunks based in part on which data chunks have copies in the same locations;
determine a break point in the sequence of data chunks based on the regions.
